(19) United States
(12) Patent Application Publication
(10) Pub. No.: US 2024/0263504 A1
(43) Pub. Date: Aug. 8, 2024

(54) METHOD FOR MOTORIZED OPENING OF A MOVABLE COVER OF A MOTOR VEHICLE AND DEVICE FOR IMPLEMENTING SUCH A METHOD

(71) Applicant: STELLANTIS AUTO SAS, Poissy (FR)

(72) Inventors: Jean Charles BERREUR, VILLEJUIF (FR); Laurent DROUOT, ST PIERRE DU PERRAY (FR); Didier SCHMITT, BAVANS (FR)

(21) Appl. No.: 18/692,681

(22) PCT Filed: Sep. 12, 2022
(86) PCT No.: PCT/FR2022/051710

§ 371 Date: Mar. 15, 2024

(30) Foreign Application Priority Data
Oct. 12, 2021 (FR) 2110774

(51) Int. Cl. E05F 15/42

(52) U.S. Cl. CPC E05F 15/42; E05F 2015/483; E05Y 2400/45; E05Y 2400/53

(57) ABSTRACT

The invention relates to a method for opening a movable cover of the type that is movable along a predefined path, between a closed position and an open position, by motorized movement means that are activatable by at least one command, the cover comprising locking means designed to immobilize the cover in the closed position, the cover comprising obstruction detection means which are designed to detect obstructions that might be found on the predefined path, the method comprising a detection step (ET1), following a user actioning (AC) a command, which step comprises using the obstruction detection means to detect an obstruction that might be found on the path, the method further comprising a deactivation step (ET2) which comprises deactivating the locking means in order to allow the cover to move, the detection step (ET1) and the unlocking step (ET2) being initiated simultaneously

### CROSS-REFERENCE TO RELATED APPLICATIONS

This application is the US National Stage under 35 USC § 371 of International Application No. PCT/FR2022/051710, filed Sep. 12, 2022, which claims the priority of French application 2110774 filed on Oct. 12, 2021, the content (text, drawings and claims) of both said applications being incorporated by reference herein.

The technical field relates to methods for motorized opening of a movable cover, the opening control devices of a movable cover implementing such a method, as well as vehicles equipped with such devices.

### BACKGROUND

Automobile manufacturers provide a variety of options that can be fitted to their vehicles, including motorized rear covers allowing automatic opening, by a simple command, of the trunk cover by motorized means. Motorized rear covers represent a most particular attraction for customers who consider such an opening as a notable improvement in the comfort offered by their vehicle once equipped with one. From the perspective of automakers, motorized doors bring non-negligible challenges and technical constraints.

Indeed, while a manually-opening cover is generally not protected, with the user on their own taking into account the environment and any obstructions, the motorized covers are generally protected against impacts by cover protection systems. Such a protection system comprises in particular an obstruction detector, positioned on the cover and coupled to the motorization device of the cover, the obstruction detection being used during the movement of the cover.

The operation of a protection system is based on an analysis of the environment of the cover during the movement thereof; if an obstruction is detected, the protection system commands the motorization system to stop the movement of the cover.

Following an action by a user, the opening of a cover implements several successive steps, in particular the unlocking of a lock and the detection of obstructions that may hinder the opening of the cover. These successive steps require relatively long durations. Thus, between the request to open and the movement of the cover, a duration of approximately 500 ms may elapse. Such a duration may be perceived negatively by the user and/or may cause the user to make a new request due to thinking that his first request was not taken into account. The subjective benefit perceived by the user of a motorized opening thus risks being reduced. The object is to overcome the problems described above. In this technical context, one aim is to provide a method for motorized opening of a cover making it possible to reduce the time needed, after a user request, to set the cover in motion.

### SUMMARY

To this end, disclosed herein is a method for motorized opening of a movable cover of a motor vehicle,
the cover being of the type capable of being moved along a predefined path, between a closed position and an open position, by motorized movement means that are activatable by at least one command, the cover comprising locking means designed to immobilize the cover in the closed position when they are activated,
the cover further comprising obstruction detection means designed to detect obstructions likely to be located on the predefined path and to allow the movement of the cover to be interrupted in the event of at least one obstruction being detected,
the method comprising a detection step, subsequent to an action by a user on a command intended to obtain the opening of the cover, the detection step consisting of implementing the obstruction detection means to detect an obstruction likely to be on the path, the method further comprising a deactivation step consisting of deactivating the locking means in order to allow the cover to move, the detection step and the unlocking step being initiated simultaneously.

Also disclosed is a device for commanding the opening of a movable cover of a motor vehicle, designed to implement a method.

Also disclosed herein is a vehicle comprising at least one described device.

Thus, during the implementation of the method, the initiation of the detection step and the deactivation step simultaneously makes it possible to reduce the time required before the cover is set in motion. Indeed, instead of a duration corresponding to the sum of the respective durations of these two steps, the method requires a duration corresponding to the duration of the longest step. The time-saving therefore corresponds to the duration of the shortest step.

According to one embodiment, the detection step comprises sending the obstruction detection means a scanning request, the scanning request being followed by scanning an area at least partially covering the path by the obstruction detection means.

Advantageously, the detection step comprises, after the scanning of the area, a sending of the scanning results to a control unit.

According to one possibility, the deactivation step comprises sending to the locking means a deactivation request followed by the implementation of the locking means in order to deactivate them.

According to one embodiment of the method, the deactivation step comprises, after the implementation of the locking means, a sending of information by the locking means to a control unit, the information relating to the activated or deactivated state of the locking means. Advantageously, when the detection step comprises sending a scanning request to the obstruction detection means, the scanning request being followed by scanning an area at least partially covering the path by the obstruction detection means, and when the detection step comprises, after the scanning of the area, a sending of the scanning results to a control unit, the implementation of the locking means is carried out during the scanning by the obstruction detection means.

According to one possibility of the method, the deactivation step and the detection step are followed by a step of moving the cover by the motorized movement means.

According to one embodiment, the device is designed to control a rear trunk cover.

### BRIEF DESCRIPTION OF THE DRAWINGS

The devices and methods described herein will be better understood upon reading the following detailed description, given solely by way of non-limiting example and with reference to the accompanying drawings, wherein:

FIG. 1 shows a schematic top view of a vehicle.

FIG. 2 schematically shows the steps of a method for opening a vehicle cover.

In these figures, the same references are used to designate the same elements.

### DETAILED DESCRIPTION

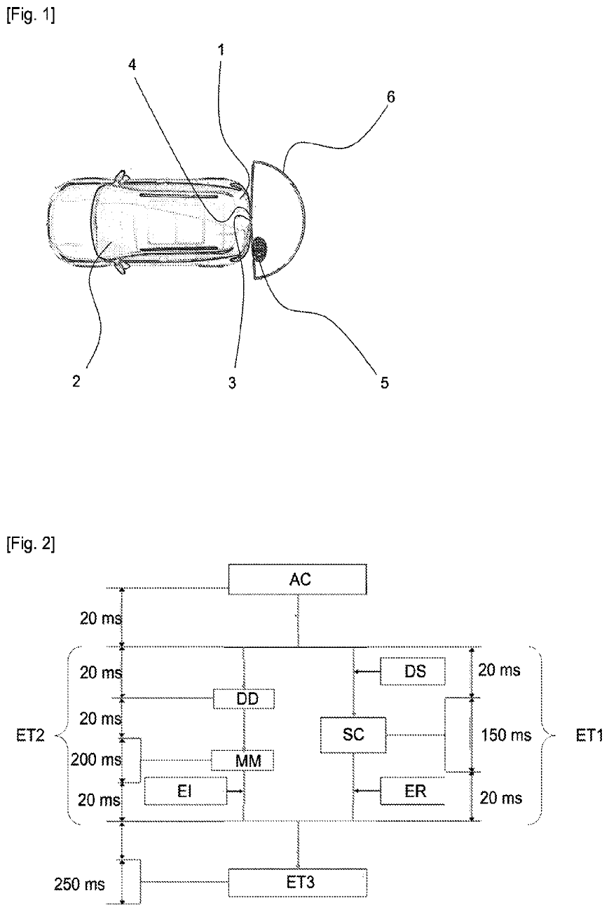

A method is designed to be executed during the motorized opening of a movable cover 1 of a motor vehicle 2, shown in FIG. 1. Such a cover 1 is of the type capable of being moved along a predefined path, between a closed position (shown in FIG. 1) and an open position, by motorized movement means and activatable by at least one command 3. The cover 1 used by the method also comprises locking means, not shown in the figure, designed to immobilize the cover 1 in the closed position when they are activated. Such locking means are for example an electrically controlled lock. The cover 1 further comprises obstruction detection means 4 designed to detect obstructions 5 likely to be located on the predefined path and to allow the movement of the cover 1 to be interrupted in the event of at least one obstruction 5 being detected.

The method comprises a detection step ET1, shown schematically in FIG. 2, is subsequent to an action AC, also shown schematically in FIG. 2, by a user on a command 3 intended to obtain the opening of the cover 1. The action AC causes an opening request to be sent to an electronic housing of the vehicle 2. Such a request requires a time of approximately 20 ms.

The detection step ET1 consists of implementing the obstruction detection means 4 to detect an obstruction 5 likely to be on the path. In the embodiment of the method described herein, the detection step ET1 requires a time of approximately 190 ms to be executed.

The method further comprises a deactivation step ET2, shown schematically in FIG. 2, which consists of deactivating the locking means in order to make the movement of the cover 1 possible. In the embodiment described, the deactivation step ET2 requires about 260 ms to be executed.

During the implementation of the method, the detection step ET1 and the unlocking step ET2 are initiated simultaneously. For example, the initiation of the detection step ET1 and of the deactivation step ET2 are initiated by a request from the electronics unit of the vehicle 2 following the action AC.

The detection step ET1 comprises sending to the obstruction detection means 4 a scanning request DS, shown schematically in FIG. 2. Such a scanning request DS is, for example, carried out by the electronics unit of the vehicle 2. In the embodiment described, the scanning request DS lasts about 20 ms.

The scanning request DS is followed by a scan SC by the means for detecting obstructions 4 in an area 6, shown in FIG. 1, at least partly covering the path. In the embodiment of the method, the scan SC requires 150 ms to be carried out. To this end, the obstruction detection means 4 comprise, for example, a radar, a lidar or any other means capable of detecting obstructions 5.

In the example of the method described, the detection step ET1 comprises, after scanning SC the area 6, sending results ER, as shown in FIG. 2, derived from the scan SC to a control unit such as an electronic control box of the motorized cover 1. Sending the results ER requires about 20 ms.

The deactivation step ET2 comprises a sending a deactivation request DD to the locking means, as shown schematically in FIG. 2. Such a deactivation request DD lasts on approximately 20 ms. As shown in FIG. 2, the electronics unit of the vehicle 2, following the action AC, sends an order to deactivate the locking means to the electronic control box. This sending requires about 20 ms. The electronic control box then sends the deactivation request DD to the locking means.

The deactivation request DD is followed by the implementation MM, shown schematically in FIG. 2, of the locking means for their deactivation. The implementation MM of the locking means requires about 200 ms.

As shown in FIG. 2, the deactivation step ET2 comprises, after the implementation MM of the locking means, sending information EI by the locking means to the control box, the information relating to the activated or deactivated state of the locking means.

Advantageously, during the implementation of the method, the implementation MM of the locking means is carried out during the scanning SC by the obstruction detection means 4.

Finally, in the method shown schematically in FIG. 2, the deactivation step ET2 and the detection step ET1 are followed by a step ET3 of moving the cover 1 by the motorized movement means, not shown in the figures.

Also related is a device for controlling the opening of the cover 1, not shown in the figure, designed to implement the method. Such a device comprises, for example, the means for motorized movement of the cover as well as the control box of the cover 1.

Thus, the method reduces the waiting time of the user measured between his action AC on the command 3 and the setting in motion of the cover 1. In the method described, this waiting time is about 280 ms, while a known method would have required 450 ms.

The methods and devices described herein are not limited to the embodiment of the method described above, only by way of example, but other embodiments can be designed by a person skilled in the art without departing from the frame and scope.

1. A method for motorized opening of a movable cover of a motor vehicle,
the cover being of the type capable of being moved along a predefined path, between a closed position and an open position, by motorized movement means that are activatable by at least one command, the cover comprising locking means designed to immobilize the cover in the closed position when they are activated,
the cover further comprises obstruction detection means designed to detect obstructions likely to be located on the predefined path and to allow the movement of the cover to be interrupted in the event of at least one obstruction being detected,
the method comprising a detection step, subsequent to an action by a user on a command intended to obtain the opening of the cover, the detection step consisting of implementing the obstruction detection means to detect an obstruction likely to be on the path, the method further comprising a deactivation step consisting of deactivating the locking means in order to allow the cover to move, the detection step and the unlocking step being initiated simultaneously.

2. The method according to claim 1, wherein the detection step comprises a sending to the obstruction detection means of a scanning request, the scanning request being followed by a scan of an area at least partially covering the path by the obstruction detection means.

3. The method according to claim 2, wherein the detection step comprises, after the scanning of the area, a sending of results of the scan to a control unit.

4. The method according to claim 1, wherein the deactivation step comprises a sending of a deactivation request to the locking means, followed by the implementation of the locking means in order to deactivate them.

5. The method according to claim 4 wherein the deactivation step comprises, after the implementation of the locking means, sending information by the locking means to a control unit, the information relating to the activated or deactivated state of the locking means.

6. The method according to claim 2, wherein the deactivation step comprises a sending of a deactivation request to the locking means, followed by the implementation of the locking means in order to deactivate them, wherein the implementation of the locking means is carried out during the scanning by the obstruction detection means.

7. The method according to claim 1, wherein the deactivation step and the detection step are followed by a step of moving the cover by the motorized movement means.

8. An opening control device for a movable cover of a motor vehicle, designed to implement a method according to claim 1.

9. The device according to claim 8, wherein it is designed to command a rear trunk cover.

10. A vehicle comprising at least one device according to claim 8.
